(19) United States
(12) Patent Application Publication
(10) Pub. No.: US 2008/0282158 A1
(43) Pub. Date: Nov. 13, 2008

(54) GLANCE AND CLICK USER INTERFACE

(75) Inventors: Antti Aaltonen, Tampere (FI); Mika Roykkee, Pirkkala (FI)

Correspondence Address: PERMAN & GREEN, 425 POST ROAD, FAIRFIELD, CT, 06824, US

(73) Assignee: Nokia Corporation, Espoo (FI)

(21) Appl. No.: 11/747,400

(22) Filed: May 11, 2007

(51) Int. Cl. G06F 3/00

(52) U.S. Cl. 715/700

(57) ABSTRACT

A user interface includes a first region configured to provide information on and access to content applications of a device and services accessible via the device, a second region configured to provide information on and access to communication applications of the device and services accessible via the device, and a divider between the first area and the second area. The divider includes a time based segment that includes a movable icon. Each of the first and second region can be divided into a first section for creating new and available content and communication application objects, a second section for active content and communication application objects, and a third section for created/received/stored content and past/recent communication objects. The movable icon can be used to select sections for viewing the underlying objects and links.

### BACKGROUND

1. Field

The disclosed embodiments generally relate to the handling of content in a device, and in particular to touch user interface devices and interaction.

2. Brief Description of Related Developments

As computing and communications devices become more complex, it can be difficult to view, access and open the various applications associated with the device quickly and easily. Devices, such as mobile communication devices include a variety of content and applications. Generally, accessing the various content or communication facilities requires opening the respective application or a control window in order to view the content. It would be advantageous to be able to easily view and interact with the various content and applications of a device.

### SUMMARY

In one aspect, the disclosed embodiments are directed to a user interface. In one embodiment, the user interface comprises a first region configured to provide information on and access to content applications of a device and a second region configured to provide information on and access to communication applications of the device. A divider can be included between the first area and the second area. The divider can comprises a time-based segment that includes a movable icon. Each of the first and second region can be configured to be divided into a first section for available content and communication application objects; a second section for active content and communication application objects; and a third section for created/received content and past/recent communication objects.

In another aspect, the disclosed embodiments are directed to a method. In one embodiment, the method comprises providing a first region on a display configured to provide information on and access to content applications of a device and a second region on the display configured to provide information on and access to communication applications of the device. A divider can be provided between the first area and the second area. The divider comprises a time-based segment that includes a movable icon. The method includes dividing each of the first and second region into a first section for providing available content and communication application objects; a second section for providing active content and communication application objects; and a third section for providing created/received content and past/recent communication objects.

In a further aspect the disclosed embodiments are directed to a computer program product. In one embodiment, the computer program product comprises a computer useable medium having computer readable code means embodied therein for causing a computer to execute a set of instructions in a device to provide a user interface for a device. The computer readable code means in the computer program product includes computer readable program code means for causing a computer to provide a first region on a display configured to provide information on and access to content applications of a device; provide a second region on the display configured to provide information on and access to communication applications of the device; and provide a divider between the first area and the second area that comprises a time based segment including a movable icon. The computer program product also includes computer readable program code means for causing a computer to divide each of the first and second region into a first section, second section and a third section; computer readable program code means for causing a computer to provide available content and communication application objects in the first section; computer readable program code means for causing a computer to provide active content and communication application objects in the second section; and computer readable program code means for causing a computer to provide created/received content and past/recent communication objects in the third section.

In yet another aspect, the disclosed embodiments are directed to an apparatus. In one embodiment, the apparatus includes a display, a user input device, and a processing device. The processing device is configured to provide at least a first region on a display that includes links, objects and information related to content applications of a device and at least a second region on the display that includes links, objects and information on communication applications of the device. The processing device can also be configured to provide a divider between the first region and the second region. The divider can be a time-based segment that includes a movable icon. The processing device can also be configured to divide each of the first and second region into a first section for providing available content and communication application objects, a second section for providing active content and communication application objects, and a third section for providing created/received content and past/recent communication objects.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIGS. 2A-2D are illustrations of exemplary screen shots of the user interface of the disclosed embodiments.

FIGS. 3 is an illustration of functions of the user interface of the disclosed embodiments.

FIGS. 4A-4C are illustrations of exemplary screen shots of functions of the user interface of the disclosed embodiments.

FIGS. 5A and 5B are illustrations of exemplary screen shots of the user interface of the disclosed embodiments.

FIG. 6A is one example of a mobile device incorporating features of the disclosed embodiments.

FIG. 6B is a block diagram illustrating the general architecture of the exemplary mobile device of FIG. 6A.

FIG. 7 illustrates one example of a schematic diagram of a network in which aspects of the disclosed embodiments may be practiced; and

FIG. 8 illustrates a block diagram of an exemplary apparatus incorporating features that may be used to practice aspects of the disclosed embodiments.

### DETAILED DESCRIPTION OF THE EMBODIMENT(S)

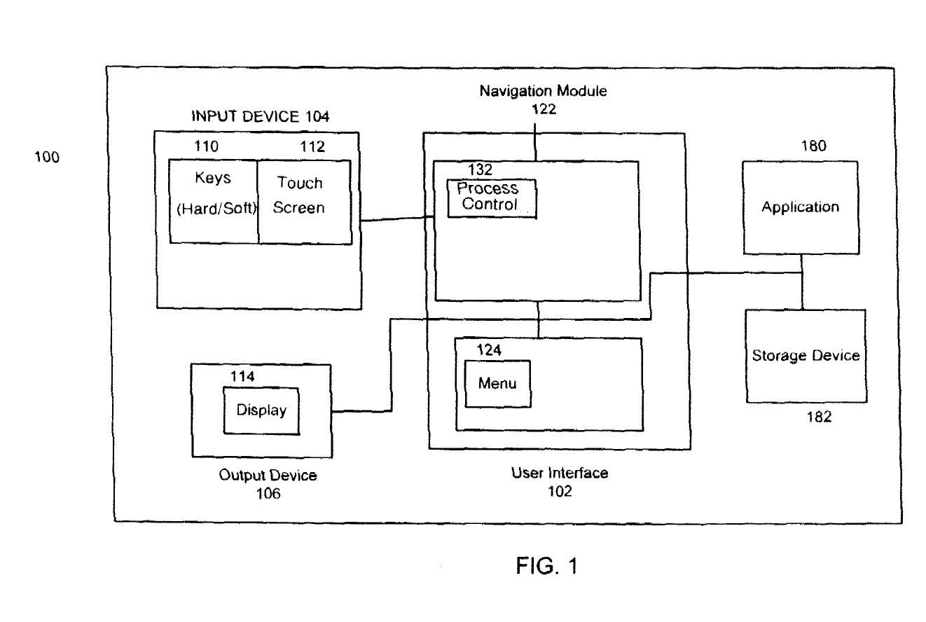

Referring to FIG. 1, one embodiment of a system 100 is illustrated that can be used to practice aspects of the claimed invention. Although aspects of the claimed invention will be described with reference to the embodiments shown in the drawings and described below, it should be understood that these aspects could be embodied in many alternate forms of embodiments. In addition, any suitable size, shape or type of elements or materials could be used.

The disclosed embodiments generally allow a user of a device or system, such as the system 100 shown in FIG. 1 to quickly and easily access and interact with frequently used actions or applications and obtained more detailed information on demand. The system 100 of FIG. 1 generally includes a user interface 102, input device 104, output device 106, applications area 180 and storage/memory device 182. The components described herein are merely exemplary and are not intended to encompass all components that can be included in a system 100. While the user interface 102, input device 104 and output device 106 are shown as separate devices, in one embodiment, the input device 104 and output device 106 can be part of, and form, the user interface 102.

In one embodiment, the input device 104 receives inputs and commands from a user and passes the inputs to the navigation module 122 for processing. The output device 106 can receive data from the user interface 102, application 180 and storage device 182 for output to the user. Each of the input device 104 and output device 106 are configured to receive data or signals in any format, configure the data or signals to a format compatible with the application or device 100, and then output the configured data or signals. While a display 114 is shown as part of the output device 106, in other embodiments, the output device 106 could also include other components and device that transmit or present information to a user, including for example audio devices and tactile devices.

The user input device 104 can include controls that allow the user to interact with and input information and commands to the device 100. For example, with respect to the embodiments described herein, the user interface 102 can comprise a touch screen display. The output device 106 can be configured to provide the content of the exemplary screen shots shown herein, which are presented to the user via the functionality of the display 114. User inputs to the touch screen display are processed by, for example, the touch screen input control 112 of the input device 104. The input device 104 can also be configured to process new content and communications to the system 100. The navigation module 122 can provide controls and menu selections, and process commands and requests. Application and content objects can be provided by the menu control system 124. The process control system 132 can receive and interpret commands and other inputs, interface with the application module 180, storage device 180 and serve content as required. Thus, the user interface 102 of the embodiments described herein, can include aspects of the input device 104 and output device 106.

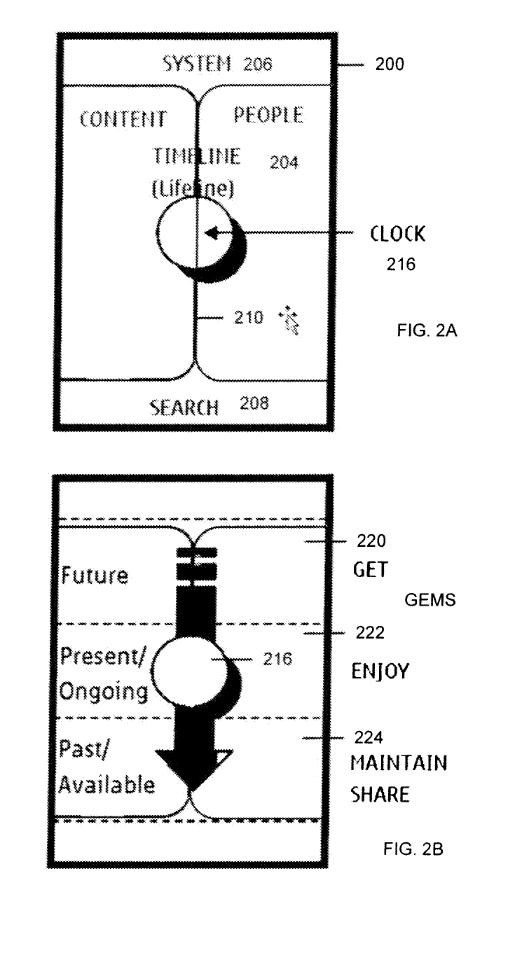

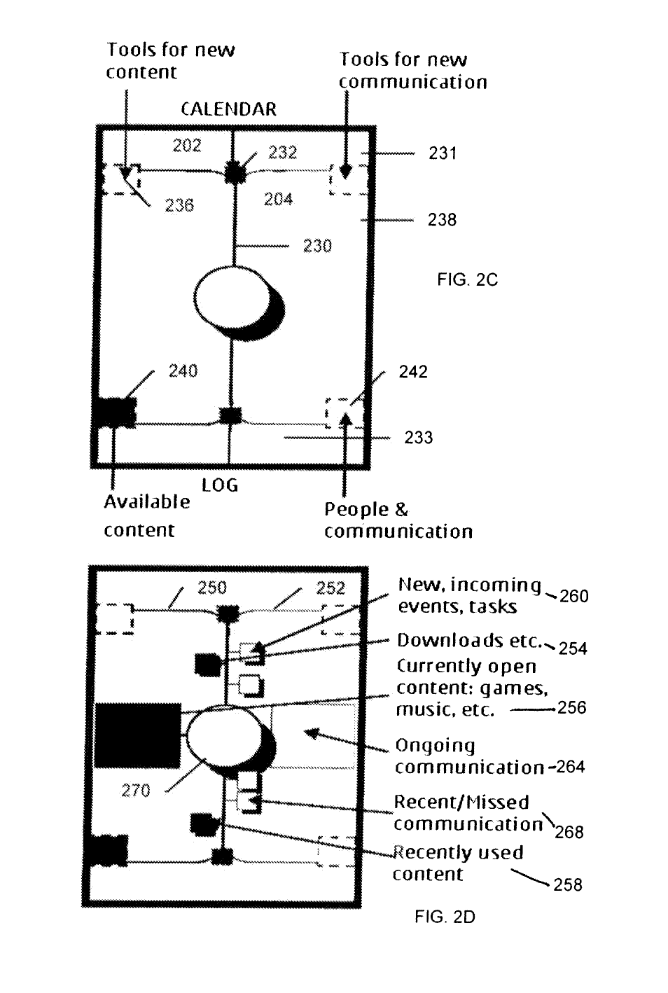

Referring to FIG. 2A, one example of a user interface 200 including aspects of the disclosed embodiments is illustrated. As shown in FIG. 2A, the user interface 200 is divided into two primary regions, a content region 202 and a communication or people region 204. In alternate embodiments, the user interface 200 can include other suitable regions, other than including a content region and a people region. For example, as shown in FIG. 2A, the user interface 200 can also include a system region 206 and a search region 208. The term “regions” as used herein is used to describe a portion of the real estate of a user interface, such as a display. Although particular terms are used to describe these regions, these terms are not intended to limit the scope of any content that may be accessible via these regions.

The content region 202 will generally include links and objects to applications and downloads. The term “application” as used herein generally refers to any application, program, file or object that can be accessed or executed on the device. This can include for example indicators, objects and links to document applications, downloads, game applications, audio-visual applications, web-browsing applications and Internet applications. These are merely examples and are not intended to limit the scope of the invention. The people or communications region 204 is generally configured to include indicators, objects and links to communication applications, including messaging, phone, phonebooks, calendar, task and event applications.

As shown in FIG. 2A, in one embodiment there is a separator 210 between the content region 202 and the people region 204. The separator 210 generally comprises a divider between the two regions. While the separator 210 is shown to be approximately midline between the two regions, in alternate embodiments the separator 210 can be positioned in any suitable location on the display or user interface of the device between the two regions. In one embodiment, the separator 210 can comprise a time line, or time-based segment. The time based segment can be scaled to provide a future segment, a current segment and a past segment. Alternatively, the separator 210 can be referred to as a lifeline, representing the life cycle of a content or communication application, from prior to use to after use. The time line can represent at one-end future actions, and at the other end past actions. A middle area or segment of the time line can represent ongoing actions and activities. The size and area of the regions and sections can be of any desired or suitable size and shape. Although the embodiments disclosed herein are generally with reference to a portrait orientation, in alternate embodiments, a landscape orientation may be implemented.

Referring to FIG. 2B, the divisions along the time line generally relate to a Get, Enjoy, Maintain and Share (“GEMS) model. The initial part 220 of the segment generally relates to the future, which is what and how the user is going to Get content and communications. Ongoing activities, approximately the middle area 222 of the time-based segment relates to the Enjoy part of the model. How and when the user is using the content and applications. The Maintain and Share aspects of the model are found towards the end segments 224 of the time line, and relate to past and available applications, how and when the content and communications were used.

In one embodiment, the two regions 202, 204 can be divided into three sections. As shown in FIG. 2B, the top section 220 relates to future activities, such as for example downloads related to not yet available content in the Content region 202, and incoming events, tasks, to-do's related to the People region 204. The middle section 222 generally relates to and provides indicators of ongoing activities in the device. These can include for example, open applications, calls, or instant messages. The bottom section 224 generally relates to past and recent communications including for example, missed calls and messages, and recently created and received content. In one embodiment, as shown in FIGS. 2A and 2B, in an idle state of the user interface 200, the movable icon 216 is positioned centrally on the display so as to form a rough division of the regions 202, 204 into the sections 220, 222 and 224. In this idle state, the movable icon 216 is positioned to correspond with the present/ongoing section 222. However, as described herein, in other embodiments, the movable icon 216 can be positioned in each of the other sections 220 and 224 when a glance view or detailed view of the content of a section is desired. In one embodiment, the movable icon 216 is configured as a timepiece, such as a clock, for example. In alternate embodiments, the movable icon 216 can be configured to being the shape of or represent any suitable graphic or device.

A more detailed example of a main view of the user interface of the disclosed embodiments is illustrated in FIG. 2C. As shown in FIG. 2C, the timeline 230 in the top section 231 generally starts with access to a calendar application 232. The access to the calendar application 232, considered a future activity or application, can generally comprise an activatable object to an underlying application. In one embodiment, the top section 231 can include an object 236 for tools applications for new content and an object 238 for new communication. Each of the tools applications will be located in a respective content 202 or people (communications) region 204. The tools for new content can include for example camera, video and voice recorder applications, document, web browsing and Internet applications. The tools for new communication can include for example, messaging and phonebook applications. In alternate embodiments, the tools for new content and new communication can include any suitable applications, and can be presented in any suitable size, shape or form.

The end of the timeline 230 in the bottom or end section 233 (past/available) can include a log application indicator or object 234. The log object 234 can include log views to each of the content and people regions 202, 204. The log view for the content region 202 can include for example, a gallery of content used. The log view for the people region 204 can include for example, a log of contacts and communications. In alternate embodiments, the log views can include any suitable information. The content region 202 can also include an available content icon 240 that will display applications that are available, while the people region 204 can include a people and communication icon 242 for recent communications and people.

Another example of a user interface of the disclosed embodiments is shown in FIG. 2D. In this embodiment, the idle screen of the user interface includes exemplary content and communications objects and indicators. For example, in the content region 250, the initial section before the movable icon 270 includes objects or indicators 254 related to downloads. In the middle region objects and indicators 256 related to currently open content. These can include for example, games and music. In the end section below the icon 270 an object or indicator 258 for recently used content is illustrated.

In the people or communication region 252, in the future section above the icon 270, objects or indicators 260 for new and incoming events and tasks are illustrated. The middle or ongoing activities section includes indicators and objects 264 for ongoing communications. The bottom section for past activities includes indicators and objects 258 for recent and missed communications.

The movable icon 216 of FIG. 2A can generally comprise any suitable icon or graphic. In one embodiment, the movable icon 216 can be in the shape or image of a timepiece, such as a clock for example. The icon 216 can be configured for finger-based touch screen interaction. In alternate embodiments, any suitable control device can be used to move the icon 216. Movement of the icon 216 along the timeline 204 will cause the display of the objects and indicators in a respective section 220-224 of the regions 202, 204.

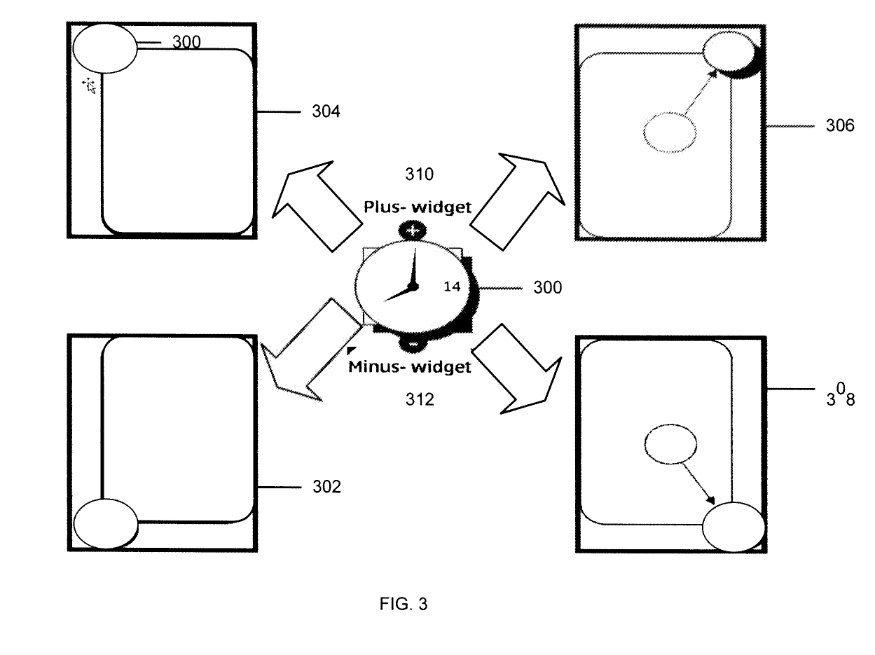

When a more detailed view of information in a section is desired, referring to FIG. 3, the movable icon 300 can be positioned over the different sections of the display of the user interface. The user interface will provide a more detailed view of the selected section, as shown in screens 302-308. The icon 300 can also include controls for adjusting a scale of the timeline, such as controls 310 and 312. These controls might also be used for fine movement of the icon 300 along the time-line, when such control is desired.

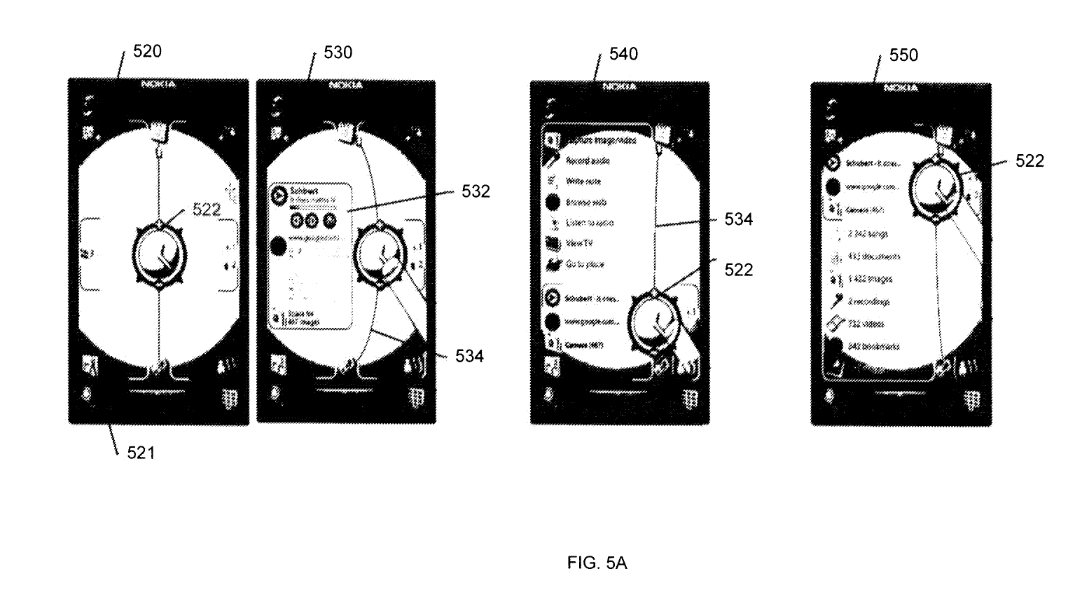

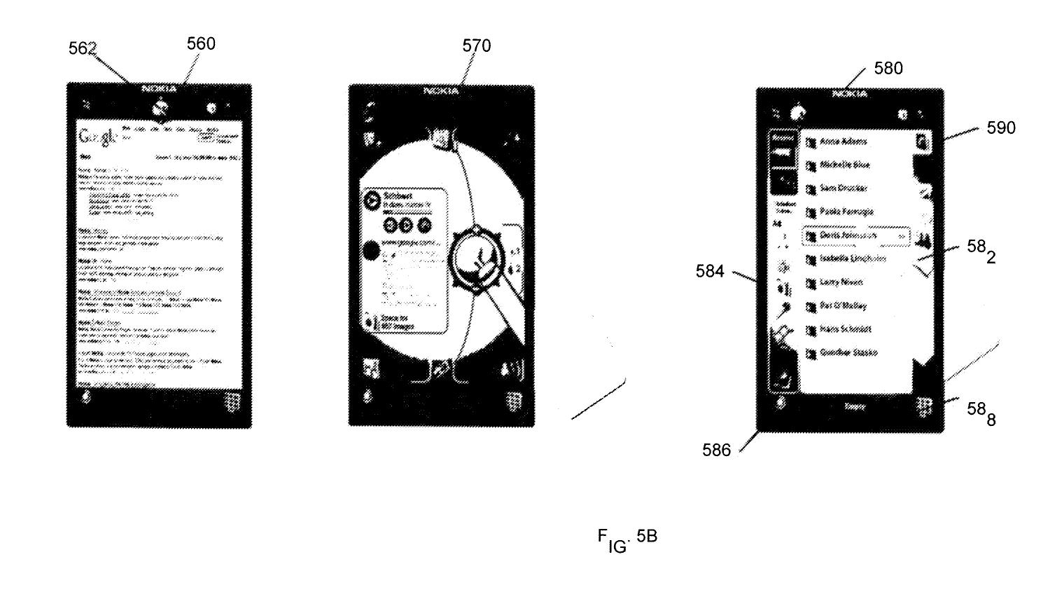

Referring to FIG. 5A, an example of an idle state of a user interface of the disclosed embodiments is shown. The movable icon 522 can initially be positioned in the middle region of the active display area of the user interface as shown in screen 520. In screen 530, moving the icon 522 is moved or positioned to the right of center to highlight ongoing applications. The user interface is configured to provide a view of the active applications 532. As shown in screen 540, the time line 534 generally follows the path of the moved icon 522. Thus, the timeline will follow the path of movement to the left or right. FIG. 5A illustrates movement and the change of shape of the timeline in the various examples. Moving the icon 522 down the timeline, as shown in screen 540, will provide or generate a view at new content related tasks, while positioning the icon 522 towards the initial section of the time line of the content region will provide or generate a view available content as shown in screen 550. In one embodiment, the active applications presented in screen 530, in the present or current time section, can be displayed in a different level of detail than applications presented in the future and past sections. In one embodiment, selecting one of the icons near the corner areas of the screen acts as a link to change the view and enlarge the related region. For instance, in screen 520 (FIG. 5A) selecting the icon 521 displayed on top of looking glass icon near the bottom left corner would open a view shown in screen 580 (FIG. 5B).

Accessing the underlying action displayed in a view, such as the active application view 532 in screen 530 of FIG. 5A can be accomplished by activating a desired object or link. In one embodiment, the clickable regions or links can be positioned near the screen edge. This can help avoid hand and finger blocking, particularly where the user interface is a finger based touch screen user interface. Selecting an item in the glance view 532, can activate the item. For example, referring to FIG. 5B, in screen 560, a full screen view is shown of a web page. Activating, or tapping the movable icon 562 in screen 560 will return the user interface to the main view shown in screen 570. In another example, in screen 580, the contacts application of the people region has been selected. A list of contacts 582, in a full or partial full screen view, is shown as a result of opening the contacts application. While the communication application contacts is predominantly presented on the real estate of the display or user interface, in one embodiment, at least a partial view 584 of the content region is shown, together with a partial view of additional view 590 of communication functions.

In the example shown in FIG. 5B, as will be described herein, each of the displayed items, in this example contacts, can be selected and acted on. In one embodiment, content from the list 584 can be accessed to be shared with a selected contact. A search area 586 can be provided that is configured to receive a selected item that is dragged and dropped, and then execute a suitable search. An area 588 is provided where items can be dragged for future action. A list 590 of communication functions can be presented which allows a user to change the current view to another communication view, such as messaging or instant messaging, for example.

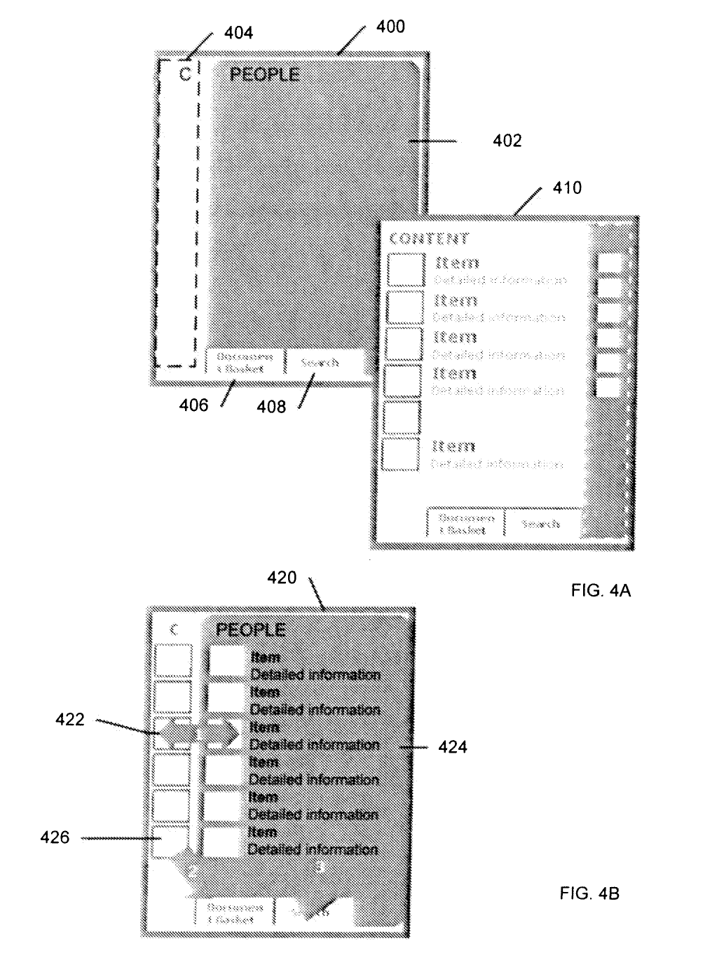

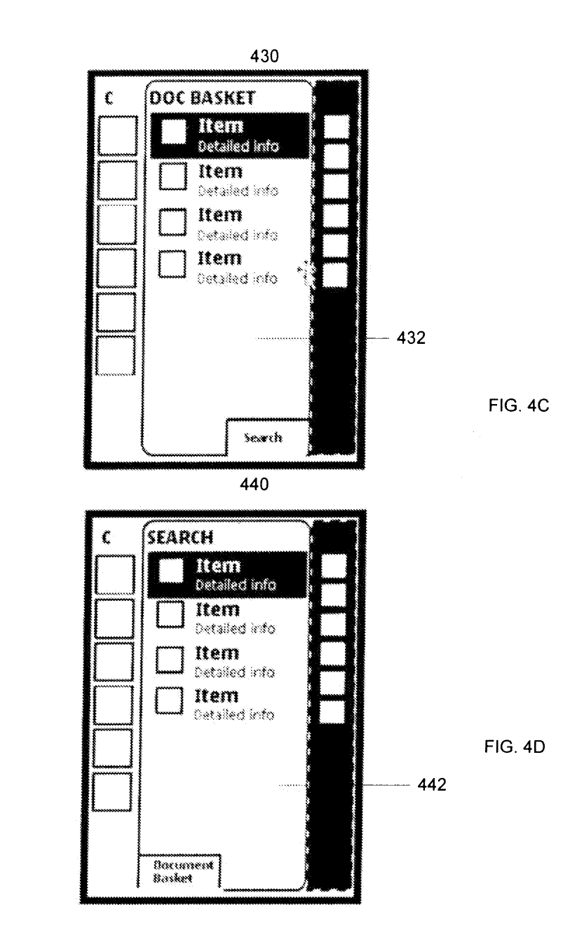

In the full screen view, in one embodiment, an overview to the other area or region will be available. For example, referring to FIG. 4A, a full screen function of the people region 402 is active, as shown in screen 400. The content region 404 is displayed in an overview fashion. In screen 410, a full screen view of the content region is displayed with an overview of the people region. As shown in screen 410, the full screen view provides selectable links to the various items making up the selected section of the content region.

The user interface can also include a document basket region 406 and a search region 408. The user can drag and drop objects in each of these regions to execute functions associated therewith. The document basket region 406 can be for storing objects temporarily for further action, such as for example, sending, sharing, editing or uploading content. The search region 408 can be used to receive an object as a seed for a content or people search.

In another embodiment, referring to FIG. 4B, the user can drag and drop objects from content to people and from people to content. As shown in screen 420 item 422 is selected and moved from the content region to the people region, in order to send a multimedia message, for example. Item 424 is selected and moved to the search region, while item 426 is moved to the document basket. Referring to FIG. 4C, items in the document basket 432 can be displayed as shown in screen 430, while search items 442 and or results and relations can be displayed as shown in screen 440.

In one embodiment, the input device 104 enables a user to provide instructions and commands to the device 100. In one embodiment, the input device 104 can include for example controls 110 and 112 for providing user input and for navigating between menu items. In alternate embodiments, the user-input device 104 can include any number of suitable input controls, data entry functions and controls for the various functions of the device 100. In one embodiment, controls 110 and 112 can take the form of a key or keys that are part of the user interface 102. Other control forms can include, for example, joystick controls, touch screen inputs and voice commands. The embodiments disclosed herein are generally described with respect to a touch screen input, but in alternate embodiments, any suitable navigation and selection control can be used.

The user interface 102 of FIG. 1 can also include a menu system 124 in the navigation module 122. The navigation module 122 provides for the control of certain processes of the device 100. The menu system 124 can provide for the selection of different tools and application options related to the applications or programs running on the device 100. In the embodiments disclosed herein, the navigation module 122 receives certain inputs, such as for example, signals, transmissions, instructions or commands related to the functions of the device 100. Depending on the inputs, the navigation module interprets the commands and directs the process control 132 to execute the commands accordingly.

Activating a control generally includes any suitable manner of selecting or activating a function associated with the device, including touching, pressing or moving the input device. In one embodiment, where the input device 104 comprises control 110, which in one embodiment can comprise a device having a keypad, pressing a key can activate a function. Alternatively, where the control 110 of input device 104 also includes a multifunction rocker style switch, the switch can be used to select a menu item and/or select or activate a function. When the input device 104 includes control 112, which in one embodiment can comprise a touch screen pad, user contact with the touch screen will provide the necessary input. Voice commands and other touch sensitive input devices can also be used.

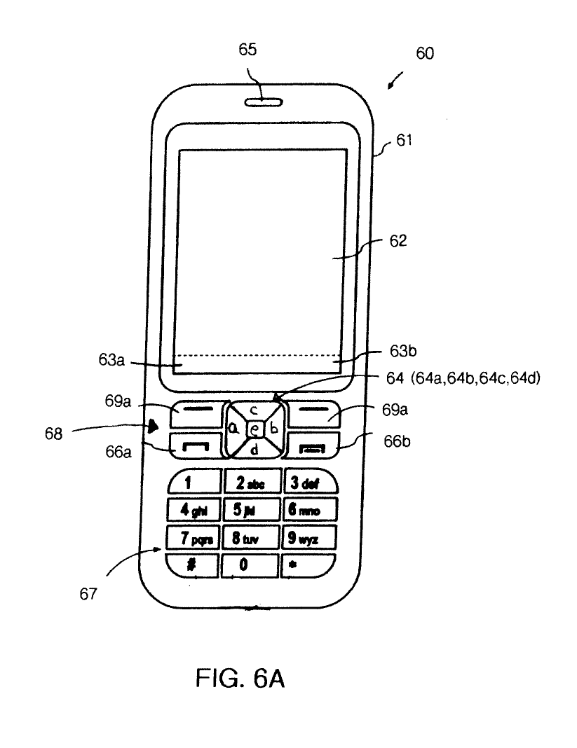

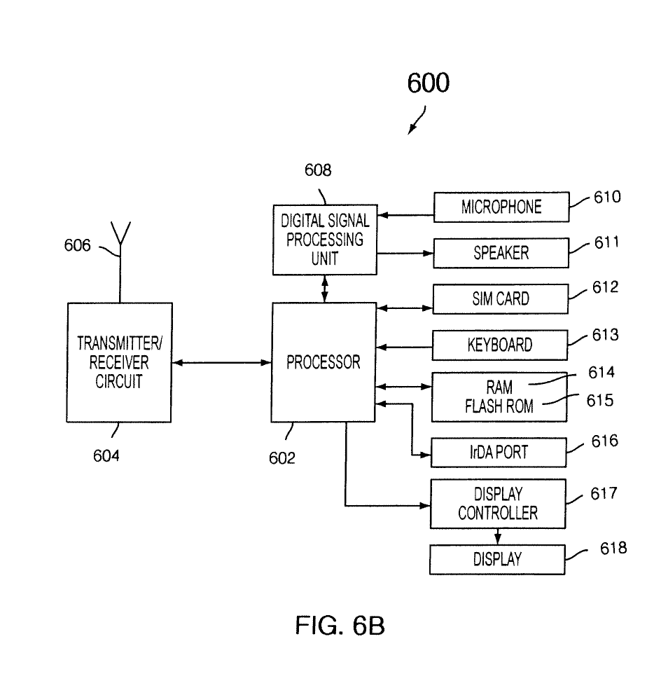

Although the above embodiments are described as being implemented on and with a mobile communication device, it will be understood that the disclosed embodiments can be practiced on any suitable device. For example, the device 100 of FIG. 1 can generally comprise any suitable electronic device, such as for example a personal computer, a personal digital assistant (PDA), a mobile terminal, a mobile communication terminal in the form of a cellular/mobile phone, or a multimedia device or computer. In alternate embodiments, the device 100 of FIG. 1 may be a personal communicator, a mobile phone, a tablet computer, a laptop or desktop computer, a television or television set top box a DVD or High Definition player or any other suitable device capable of containing for example a display 114 shown in FIG. 1, and supported electronics such as the processor 617 and memory 602 of FIG. 6. For description purposes, the embodiments described herein will be with reference to a mobile communications device for exemplary purposes only and it should be understood that the embodiments could be applied equally to any suitable device incorporating a display, processor, memory and supporting software or hardware.

Referring again to FIG. 1, in one embodiment the device 100 has a user interface that can include the user input device 104. The user input device can include a keypad with a first group of keys, such as keypad 67 shown in FIG. 6A. The keys 67 can be alphanumeric keys and can be used for example to enter a telephone number, write a text message (SMS), or write a name (associated with the phone number). Each of the twelve alphanumeric keys 67 shown in FIG. 6A can be associated with a alphanumeric such as “A-Z” or “0-9”, or a symbol, such as “#” or “*”, respectively. In alternate embodiments, any suitable number of keys can be used, such as for example a QUERTY keyboard, modified for use in a mobile device. In an alpha mode, each key 67 can be associated with a number of letters and special signs used in the text editing. In one embodiment, the user input device can include a on-screen keypad or hand-writing recognition area that can be opened, for example, by selecting a user interface component that may receive alphanumeric input as the text box on the bottom middle or by clicking the keypad icon on the bottom right corner in screen 580 (FIG. 5B.)

The user interface 102 of the device 100 of FIG. 1 can also include a second group of keys, such as keys 68 shown in FIG. 6A that can include for example, soft keys 69a, 69b, call handling keys 66a, 66b, and a multi-function/scroll key 64. The call handling keys 66a and 66b can comprise a call key (on hook) and an end call (off hook). The keys 68 can also include a 5-way navigation key 64a-64d (up, down, left, right and center, select/activate). The function of the soft keys 69a and 69b generally depends on the state of the device, and navigation in the menus of applications of the device can be performed using the navigation key 64. In one embodiment, the current function of each of the soft keys 69a and 69b can be shown in separate fields or soft labels in respective dedicated areas 63a and 63b of the display 62. These areas 63a and 63b can generally be positioned in areas just above the soft keys 69a and 69b. The two call handling keys 66a and 66b are used for establishing a call or a conference call, terminating a call or rejecting an incoming call. In alternate embodiment, any suitable or key arrangement and function type can make up the user interface of the device 60, and a variety of different arrangements and functionalities of keys of the user interface can be utilized.

In one embodiment, the navigation key 64 can comprise a four- or five-way key which can be used for cursor movement, scrolling and selecting (five-way key) and is generally placed centrally on the front surface of the phone between the display 62 and the group of alphanumeric keys 67. In alternate embodiments, the navigation key 64 can be placed in any suitable location on user interface of the device 60.

Referring to FIG. 1, the display 114 of the device 100 can comprise any suitable display, such as for example, a touch screen display or graphical user interface. In one embodiment, the display 114 can be integral to the device 100. In alternate embodiments the display may be a peripheral display connected or coupled to the device 100. A pointing device, such as for example, a stylus, pen or simply the user's finger may be used with the display 114. In alternate embodiments any suitable pointing device may be used. In other alternate embodiments, the display may be any suitable display, such as for example a flat display 114 that is typically made of an LCD with optional back lighting, such as a TFT matrix capable of displaying color images. A touch screen may be used instead of a conventional LCD display.

The device 100 may also include other suitable features such as, for example, a camera, loudspeaker, connectivity port or tactile feedback features.

FIG. 6B illustrates, in block diagram form, one embodiment of a general architecture of a mobile device 50. In the system 600, the processor 602 controls the communication with the network via the transmitter/receiver circuit 604 and an internal antenna 606. The microphone 610 transforms speech or other sound into analog signals. The analog signals formed are A/D converted in an A/D converter (not shown) before the speech is encoded in a digital signal-processing unit 608 (DSP). The encoded speech signal is transferred to the processor 602. The processor 602 also forms the interface to the peripheral units of the apparatus, which can include for example, a SIM card 612, keyboard or keypad 613, a RAM memory 614 and a Flash ROM memory 615, IrDA port(s) 616, display controller 617 and display 618, as well as other known devices such as data ports, power supply, etc. The digital signal-processing unit 608 speech-decodes the signal, which is transferred from the processor 608 to the speaker 611 via a D/A converter (not shown).

The processor 618 can also include memory for storing any suitable information and/or applications associated with the mobile communications device 50 such as phone book entries, calendar entries, etc.

In alternate embodiments, any suitable peripheral units for the device 50 can be included.

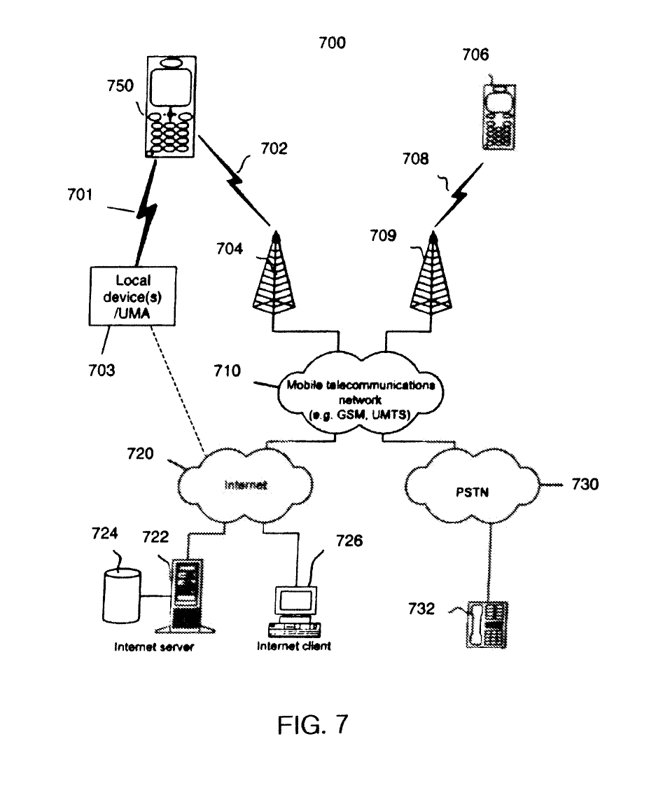

Referring to FIG. 7, one embodiment of a communication system in which the disclosed embodiments can be used is illustrated. In the communication system 100 of FIG. 7, various telecommunications services such as cellular voice calls, Internet, wireless application protocol browsing, cellular video calls, data calls, facsimile transmissions, music transmissions, still image transmission, video transmissions, electronic message transmissions and electronic commerce may be performed between the mobile terminal 750 and other devices, such as another mobile terminal 706, a stationary telephone 732, or an internet server 722. It is to be noted that for different embodiments of the mobile terminal 750 and in different situations, different ones of the telecommunications services referred to above may or may not be available. The aspects of the invention are not limited to any particular set of services in this respect.

The mobile terminals 750, 706 may be connected to a mobile telecommunications network 710 through radio frequency (RF) links 702, 708 via base stations 704, 709. The mobile telecommunications network 710 may be in compliance with any commercially available mobile telecommunications standard such as, for example, GSM, UMTS, D-AMPS, CDMA2000, FOMA and TD-SCDMA or other such suitable communication standard or protocol.

The mobile telecommunications network 710 may be operatively connected to a wide area network 720, which may be the Internet or a part thereof. An Internet server 722 has data storage 724 and can be connected to the wide area network 720, as is for example, an Internet client computer 726. The server 722 may host a www/wap server capable of serving www/wap content to the mobile terminal 700. In alternate embodiments, the server 722 can host any suitable transaction oriented protocol.

For example, a public switched telephone network (PSTN) 730 may be connected to the mobile telecommunications network 710 in a familiar manner. Various telephone terminals, including the stationary telephone 732, may be connected to the PSTN 730.

The mobile terminal 750 is also capable of communicating locally via a local link 701 to one or more local devices 703. The local link 701 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 703 can, for example, be various sensors that can communicate measurement values to the mobile terminal 700 over the local link 701. The above examples are not intended to be limiting, and any suitable type of link may be utilized. The local devices 703 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the Internet. The mobile terminal 750 may thus have multi-radio capability for connecting wirelessly using mobile communications network 710, WLAN or both. Communication with the mobile telecommunications network 710 may also be implemented using WiFi, WiMax, or any other suitable protocols, and such communication may utilize unlicensed portions of the radio spectrum (e.g. unlicensed mobile access (UMA)).

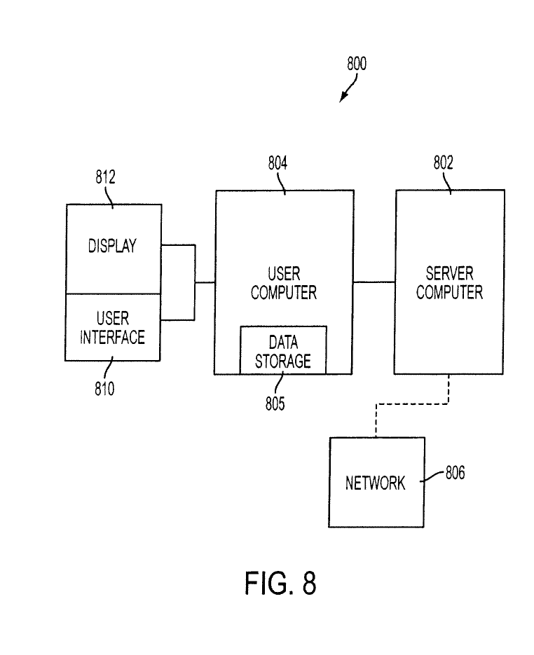

The disclosed embodiments may also include software and computer programs incorporating the process steps and instructions described above that are executed in different computers. FIG. 8 is a block diagram of one embodiment of a typical apparatus 800 incorporating features that may be used to practice aspects of the invention. The apparatus 800 can include computer readable program code means for carrying out and executing the process steps described herein. As shown, a computer system 802 may be linked to another computer system 804, such that the computers 802 and 804 are capable of sending information to each other and receiving information from each other. In one embodiment, computer system 802 could include a server computer adapted to communicate with a network 806. Computer systems 802 and 804 can be linked together in any conventional manner including, for example, a modem, wireless, hard wire connection, or fiber optic link. Generally, information can be made available to both computer systems 802 and 804 using a communication protocol typically sent over a communication channel or through a dial-up connection on ISDN line. Computers 802 and 804 are generally adapted to utilize program storage devices embodying machine-readable program source code, which is adapted to cause the computers 802 and 804 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 802 and 804 may also include a microprocessor for executing stored programs. Computer 802 may include a data storage device 808 on its program storage device for the storage of information and data. The computer program or software incorporating the processes and method steps incorporating aspects of the invention may be stored in one or more computers 802 and 804 on an otherwise conventional program storage device. In one embodiment, computers 802 and 804 may include a user interface 810, and a display interface 812 from which aspects of the invention can be accessed. The user interface 810 and the display interface 812 can be adapted to allow the input of queries and commands to the system, as well as present the results of the commands and queries.

The disclosed embodiments generally provide for a user to be able to have fast and easy access to frequently used actions or applications and obtain more detailed information on demand related to new, current and old content, such as for example, downloads, applications, tasks, events, contacts, messages and communications. Using a click and glance interaction, the user interface of the disclosed embodiments allows a user to scroll along a time-line divider between content and communications. The timeline divides the regions into sections arranged along future, present/ongoing and past/available content and communication. The user scrolls along the divider, or timeline, in order to view content and communications in each section. When a more detailed look is desired, as simple move of the movable icon, referred to herein as a clock, over the desired section can provide an enhanced view of the content or communication objects in the section. User interaction with a desired object can be as simple as clicking on the object or link to execute the underlying application, or obtain a more detailed view of the item or action on demand. Items are easily selected and moved between the content region and the communication region, when such interaction of an item between regions is suitable, such as for example the communication, such as emailing a content attachment, such as audio-visual content. Storage regions are provided for accumulating items for future action or search activities, with corresponding displays. The regions and sections of the user interface are scalable, as is the orientation between portrait and landscape views. Icons, layouts are all customizable. Generally, the user interface will comprise a touch screen interface that includes clickable regions, typically near the edge of the screen. However, any mode of moving icons or selecting a link or object can be implemented. Thus, the disclosed embodiments allow a user to easily and quickly determine what is available to Get, what is being Enjoyed and what can be Maintained and Shared, the GEMS model.

It should be understood that the foregoing description is only illustrative of the embodiments. Various alternatives and modifications can be devised by those skilled in the art without departing from the embodiments. Accordingly, the disclosed embodiments are intended to embrace all such alternatives, modifications and variances that fall within the scope of the appended claims.

What is claimed is:

1. A user interface comprising:
a first region configured to provide information on and access to content applications of a device; and
a second region configured to provide information on and access to communication applications of the device.

2. The user interface of claim 1 further comprising:
at least one tools area, the at least one tools area comprising tools for new applications in a region;
at least one log area, the at least one log area providing data on available applications in a region;
at least one object in the first region, the at least one object providing information on and access to:
available applications and downloads for the device; or
currently open applications and content on the device; or
recently used content on the device; and
at least one object in the second region providing information on and access to:
incoming events, communications, tasks and future calendar items;
active and ongoing communications in the device; or
recent and missed communications.

3. The user interface of claim 1 further comprising a divider between the first region and the second region, the divider comprising a time based segment that includes a movable icon; and wherein the first and second region are further configured to be divided into:
a first section for available content and communication application objects;
a second section for active content and communication application objects; and
a third section for created/received content and past/recent communication objects.

4. The user interface of claim 3 wherein the content applications and communication applications each include respective content services and communication services accessible via the device.

5. The user interface of claim 3 further comprising a calendar application in the first section on a segment of the divider.

6. The user interface of claim 3 further comprising, in the first section, a tools area for the first region and a tools area for the second region, the tools area of the first region comprising tools for new content and the tools area for the second region comprising tools for new communication.

7. The user interface of claim 3 further comprising, in the third section, at least one log area along a segment of the divider.

8. The user interface of claim 3 further comprising, in the third section, a log area for the first region and a log area for the second region, the log area for the first region providing available content and the log area for the second region providing available contacts.

9. The user interface of claim 3 further comprising at least one object in the first section of the first region that provides information on and access to inactive applications and downloads for the device.

10. The user interface of claim 3 further comprising at least one object in the first section of the second region that provides information on and access to incoming events, communications, tasks, and future calendar items.

11. The user interface of claim 3 further comprising at least one object in the second section of the first region that provides information on and access to content and applications that are currently open on the device.

12. The user interface of claim 3 further comprising at least one object in the second section of the second region that provides information on and access to active and ongoing communication with the device.

13. The user interface of claim 3 further comprising at least one object in the third section of the first region that provides information on and access to content recently used on the device.

14. The user interface of claim 3 further comprising at least one object in the third section of the first region that provides information on recent and missed communications with the device.

15. The user interface of claim 3 further comprising at least one preview area configured to provide an exploded view of objects in a section of a region when the movable icon is positioned over the section.

16. The user interface of claim 3 wherein the movable icon further comprises at least one control mechanism configured to adjust a scale of the time based segment.

17. The user interface of claim 3 wherein at least one section includes links to applications.

18. The user interface of claim 3 wherein the second section includes indicators of ongoing activities.

19. The user interface of claim 3 further comprising objects related to content in the first region and objects related to communication in the second region, wherein:
the first section comprises objects related to new content, incoming communications and new calendar events and tasks;
the second section comprises objects related to open content, active applications and ongoing communications; and
the third section comprises objects related to used content and past/missed communications.

20. The user interface of claim 19 further comprising a calendar object on segment of the divider and a log object on a segment of the divider.

21. The user interface of claim 20 wherein the movable icon further comprises at least one time control device configured to adjust a scale of the time based segment.

22. The user interface of claim 21 further comprising links to applications in each of the first and third sections and indicators of ongoing activities in the second section.

23. A method comprising:
providing a first region on a display configured to provide information on and access to content applications of a device; and
providing a second region on the display configured to provide information on and access to communication applications of the device.

24. The method of claim 23 further comprising:
providing at least one tools area, the at least one tools area comprising tools for new applications in a region;
providing at least one log area, the at least one log area providing data on available applications in a region;
providing at least one object in the first region, the at least one object providing information on and access to:
available applications and downloads for the device; or
currently open applications and content on the device; or
recently used content on the device; and
providing at least one object in the second region providing information on and access to:
incoming events, communications, tasks and future calendar items;
active and ongoing communications in the device; or
recent and missed communications.

25. The method of claim 23 further comprising:
providing a divider between the first region and the second region, the divider comprising a time-based segment that includes a movable icon, and
dividing each of the first and second region into:
a first section for providing available content and communication application objects;
a second section for providing active content and communication application objects; and
a third section for providing created/received content and past/recent communication objects.

26. The method of claim 24 comprising moving the movable icon along the time-based segment to view objects and indicators in each section.

27. The method of claim 24 comprising moving the movable icon to a section of a region to view objects and indicators in the section.

28. The method of claim 24 comprising expanding a view of the objects and indicators in the section when the movable icon is positioned over the section.

29. The method of claim 24 further comprising selecting an object in the section to access a full screen view of the object.

30. The method of claim 29 further comprising activating the movable icon to return to a previous view.

31. The method of claim 24 comprising:
positioning the movable icon near the first section of the first region to view indicators for available content and applications;
positioning the movable icon near the second section of the first region to view indicators for active applications; and
positioning the movable icon near the third section of the first region to view recently created and received content.

32. The method of claim 31 further comprising:
positioning the movable icon near the first section of the second region to view indicators for new and incoming communications, events and tasks;
positioning the movable icon near the second section of the second region to view indicators for active communications; and
positioning the movable icon near the third section of the second region to view recent and missed communications.

33. The method of claim 32 further comprising displaying indicators in the second section with greater detail than indicators in the first and third sections.

34. The method of claim 32 further comprising expanding a view of indicators for a section when the movable icon is positioned over the section.

35. The method of claim 24 further comprising providing a calendar application object on the time-based segment and a log application object on the time-based segment.

36. The method of claim 24 comprising the time-based segment maintaining a contiguous path when the movable icon is positioned over a section.

37. The method of claim 24 comprising sliding the movable indicator along the time-based segment to display objects and indicators corresponding to a section and positioning the movable indicator over the section to obtain an expanded view of the objects and indicators.

38. The method of claim 24 further comprising:
providing an expanded region view of a selected region and an overview of the non-selected region when a region view selection control is activated; and
displaying each item as a selectable item with detailed information.

39. The method of claim 38 further comprising providing an object storage facility indicator and a search control in the expanded region view.

40. The method of claim 39 further comprising selecting an item displayed in the expanded region view and moving the selected item to the object storage facility for further action.

41. The method of claim 39 further comprising selecting an item displayed in the expanded region view and moving the item to the search control to conduct a universal search related to the selected item.

42. The method of claim 41 further comprising displaying search results of the universal search in-between the expanded region view and the non-expanded region view.

43. The method of claim 38 further comprising selecting an item in either the expanded region view or the non-expanded region view and moving the selected item to the other region.

44. The method of claim 24 further comprising changing a scale of the time-based segment by activating a control on the movable icon.

45. A computer program product comprising:
a computer useable medium having computer readable code means embodied therein for causing a computer to execute a set of instructions in a device to provide a user interface for a device, the computer readable code means in the computer program product comprising:
computer readable program code means for causing a computer to provide a first region on a display configured to provide information on and access to content applications of a device;
computer readable program code means for causing a computer to provide a second region on the display configured to provide information on and access to communication applications of the device;
computer readable program code means for causing a computer to provide a divider between the first region and the second region, the divider comprising a time based segment that includes a movable icon; and
computer readable program code means for causing a computer to divide each of the first and second region into a first section, second section and a third section;
computer readable program code means for causing a computer to provide available content and communication application objects in the first section;
computer readable program code means for causing a computer to provide active content and communication application objects in the second section; and
computer readable program code means for causing a computer to provide created/received content and past/recent communication objects in the third section.

46. The computer program product of claim 45 further comprising computer readable program code means for causing a computer to move the movable icon along the time-based segment to view objects and indicators in each section.

47. The computer program product of claim 45 further comprising computer readable program code means for causing a computer to move the movable icon to a section of a region to view objects and indicators in the section.

48. The computer program product of claim 45 further comprising:
computer program code means for causing a computer to display indicators for available content and applications when the movable icon is positioned near the first section of the first region;
computer program code means for causing a computer to display indicators for active applications when the movable icon is positioned near the second section of the first region; and
computer program code means for causing a computer to display indicators for recently created and received content when the movable icon is positioned near the third section of the first region.

49. The computer program product of claim 48 further comprising:
computer program code means for causing a computer to display indicators for new and incoming communications, events and tasks when the movable icon is positioned near the first section of the second region;
computer program code means for causing a computer to display indicators for active communications when the movable icon is positioned near the second section of the second region; and
computer program code means for causing a computer to display indicators for recent and missed communications when the movable icon is positioned near the third section of the second region.

50. An apparatus comprising:
a display;
a user input device; and
a processing device configured to:
provide at least a first region on a display that includes links, objects and information related to content applications of a device; and
provide at least a second region on the display that includes links, objects and information on communication applications of the device.

51. The apparatus of claim 50 further comprising the processing device configured to provide:
at least one tools area, the at least one tools area comprising tools for new applications in a region;
at least one log area, the at least one log area providing data on available applications in a region;
at least one object in the first region, the at least one object providing information on and access to:
available applications and downloads for the device; or
currently open applications and content on the device; or
recently used content on the device; and
at least one object in the second region providing information on and access to:
incoming events, communications, tasks and future calendar items;
active and ongoing communications in the device; or
recent and missed communications.

52. The apparatus of claim 50 further comprising the processing device being configured to provide a divider between the first region and the second region, the divider comprising a time-based segment that includes a movable icon, the processing device being further configured to:
divide each of the first and second region into:
a first section for providing available content and communication application objects;
a second section for providing active content and communication application objects; and
a third section for providing created/received content and past/recent communication objects.

53. The apparatus of claim 50, further comprising the processing device being configured to display objects in a section when the movable icon is positioned at or near the section.

54. The apparatus of claim 53 further comprising the processing device being configured to:
position the movable icon near the first section of the first region to view indicators for available content and applications;
position the movable icon near the second section of the first region to view indicators for active applications; and
position the movable icon near the third section of the first region to view recently created and received content.

55. The apparatus of claim 53 wherein the apparatus is a mobile communication device.
